(19) United States
(12) Patent Application Publication
(10) Pub. No.: US 2026/0128810 A1
(43) Pub. Date: May 7, 2026

(54) PROPAGATION ENVIRONMENT REPRODUCTION DEVICE, PROPAGATION ENVIRONMENT REPRODUCTION METHOD, AND PROPAGATION ENVIRONMENT REPRODUCTION SYSTEM

(71) Applicant: NTT, Inc., Tokyo (JP)

(72) Inventors: Ryotaro TANIGUCHI, Musashino-shi, Tokyo (JP); Tomoki MURAKAMI, Musashino-shi, Tokyo (JP); Tomoaki OGAWA, Musashino-shi, Tokyo (JP); Yasushi TAKATORI, Musashino-shi, Tokyo (JP)

(73) Assignee: NTT, Inc., Tokyo (JP)

(21) Appl. No.: 19/117,963

(22) PCT Filed: Oct. 4, 2022
(86) PCT No.: PCT/JP2022/037161

§ 371 Date: Apr. 3, 2025

(51) Int. Cl. H04B 17/391; H04B 7/04

(52) U.S. Cl. CPC H04B 17/391; H04B 7/04013

(57) ABSTRACT

There is provided a propagation environment reproduction device including: an anechoic chamber that blocks an electromagnetic wave from the outside; reconfigurable intelligent surfaces (RISs) that are installed in the anechoic chamber; a RIS control device that provides a control signal to the RISs; a transmission antenna that is installed in the anechoic chamber; a channel emulator that controls a characteristic of an electromagnetic wave transmitted from the transmission antenna; a reception antenna that is installed in the anechoic chamber as an evaluation target; and a control server that controls the RIS control device and the channel emulator. The RIS includes a first RIS that has a characteristic of changing transmittance of the electromagnetic wave according to the control signal and is disposed between the transmission antenna and the reception antenna.

### TECHNICAL FIELD

The present disclosure relates to a propagation environment reproduction device, a propagation environment reproduction method, and a propagation environment reproduction system, and particularly relates to a propagation environment reproduction device, a propagation environment reproduction method, and a propagation environment reproduction system suitable for reproducing a propagation environment for verifying communication performance and the like of a measurement object.

### BACKGROUND ART

Non Patent Literature 1 described below discloses a technology related to an over the air (OTA) test for verifying the performance and quality of a device that is used for wireless communication as a measurement object. In the OTA test, one or a plurality of transmission antennas are disposed in an anechoic chamber or a shielded room, and an environment exhibiting the same propagation characteristics as the propagation characteristics of a real space is reproduced in the space.

In a case where a communication quality and the like of a measurement object are measured in a propagation environment in which the propagation characteristic occurring in a real space is reproduced, the communication quality and the like exhibited in the real space can be measured. Therefore, in a case where the OTA method is used, it is possible to easily and accurately evaluate the performance and the like of a device used for wireless communication.

### CITATION LIST

### Non Patent Literature

Non Patent Literature 1: “MIMO OTA Test for a Mobile Station Performance Evaluation”, Ya Jing, Hongwei Kong, and Moray Rumney, IEEE Instrumentation & Measurement Magazine, p43-p50, June 2016

### SUMMARY OF INVENTION

### Technical Problem

Incidentally, the largest problem with implementation of the OTA test is how to accurately reproduce a desired wireless propagation environment occurring in a real space. Meanwhile, as a device that controls reflection of radio waves, a reflector called a reconfigurable intelligent surface (RIS) is known.

The RIS is a reflector which uses a metamaterial technology and of which the characteristic is variable.

Metamaterial means to artificially change a characteristic of a substance. According to a metamaterial technology, for example, a phenomenon in which a refractive index of an electromagnetic wave becomes a negative value may also occur.

In addition, the RIS can be provided with a characteristic of making a reflection direction of the electromagnetic wave variable according to a control signal and a characteristic of making reflection power of the electromagnetic wave variable according to a control signal. In a case of performing the OTA test, if the RIS having such characteristics is installed on a ceiling, a wall surface, a floor surface, or the like of the anechoic chamber and a control signal applied to the RIS is appropriately controlled, various reflection environments can be created in the anechoic chamber.

In the OTA test, it is desirable to simulate measurements in various spaces that exist in reality and measurements at various measurement positions in each real space. In a case where the RIS that makes the reflection direction and the reflection power variable is used as described above, various propagation environments can be created by setting of a single anechoic chamber. Thus, measurement efficiency can be significantly enhanced.

However, as an actual propagation environment, for example, a situation is assumed in which the electromagnetic wave arrives only from the left and right of a measurement object and the electromagnetic wave does not arrive from the front of the measurement object. On the other hand, In a built-in anechoic chamber, when a transmission antenna of an electromagnetic wave and a measurement object are placed in a mutually visible arrangement, a direct path from the transmission antenna to the measurement object cannot be controlled even if an RIS that can change a reflection direction and reflection power is controlled in any way. That is, even in a case where it is desired to reduce the power of a path from a transmission direction to zero, it is not possible to prevent a direct wave from arriving at the measurement object.

Under such conditions, in order to reproduce a more realistic propagation environment, it is necessary to reduce or control the power of the direct waves from the transmission antenna toward the measurement object. However, it is impossible to reproduce such an environment by combining a RIS that controls the reflection direction and a RIS that controls the reflection power.

The present disclosure has been made in view of the above problems, and a first object of the present disclosure is to provide a propagation environment reproduction device capable of reproducing any propagation environment by disposing a RIS that controls direct waves in a space such as an anechoic chamber.

Further, a second object of the present disclosure is to provide a propagation environment reproduction method capable of reproducing any propagation environment by disposing a RIS that controls direct waves in a space such as an anechoic chamber.

Further, a third object of the present disclosure is to provide a propagation environment reproduction system capable of reproducing any propagation environment by disposing a RIS that controls direct waves in a space such as an anechoic chamber.

### Solution to Problem

In order to achieve the above object, according to a first aspect, preferably, there is provided a propagation environment reproduction device including: a reconfigurable intelligent surface (RIS) that is installed in a propagation environment reproduction space for reproducing a propagation environment of an electromagnetic wave; a RIS control device that provides a control signal to the RIS; a transmission antenna that is installed in the propagation environment reproduction space; a channel emulator that controls a characteristic of an electromagnetic wave transmitted from the transmission antenna; a reception antenna that is installed in the propagation environment reproduction space as an evaluation target; and a control server that controls the RIS control device and the channel emulator, in which the RIS includes a first RIS that has a characteristic of changing transmittance of the electromagnetic wave according to the control signal and is disposed between the transmission antenna and the reception antenna.

Further, according to a second aspect, preferably, there is provided a propagation environment reproduction method for reproducing a desired propagation environment at a position of a reception antenna that is installed in a propagation environment reproduction space for reproducing a propagation environment of an electromagnetic wave by using a RIS that is installed in the propagation environment reproduction space and a transmission antenna that is installed in the propagation environment reproduction space, the RIS including a first RIS that has a characteristic of changing transmittance of the electromagnetic wave according to the control signal and is disposed between the transmission antenna and the reception antenna, the propagation environment reproduction method including: calculating, while changing parameters related to the propagation environment reproduction space, the RIS, and the transmission antenna, a propagation characteristic caused in the propagation environment reproduction space under each of said parameters by a simulation; creating a learning model that derives, when a propagation characteristic to be reproduced is provided, a parameter causing said propagation characteristic in the propagation environment reproduction space, the learning model being obtained by providing to a propagation environment model as training data a combination of an actual characteristic that is a propagation characteristic actually measured at a measurement position in a real space and a reproduction parameter that is a parameter calculated to cause a propagation characteristic which is same as the actual characteristic in the propagation environment reproduction space; causing the learning model to derive a parameter for causing a desired propagation characteristic by providing the desired propagation characteristic to the learning model; configuring the propagation environment reproduction space according to a specification indicated by the parameter derived by the learning model; disposing the RIS and the transmission antenna in the propagation environment reproduction space according to the specification indicated by the parameter derived by the learning model; controlling the first RIS such that the first RIS has transmittance indicated by the parameter derived by the learning model; and controlling a transmission signal from the transmission antenna such that the transmission antenna transmits an electromagnetic wave with a characteristic indicated by the parameter derived by the learning model.

Further, according to a third aspect, preferably, there is provided a propagation environment reproduction system including: a RIS that is installed in a propagation environment reproduction space for reproducing a propagation environment of an electromagnetic wave; a transmission antenna that is installed in the propagation environment reproduction space; and a reception antenna that is installed in the propagation environment reproduction space as an evaluation target, in which the RIS includes a first RIS that has a characteristic of changing transmittance of the electromagnetic wave according to the control signal and is disposed between the transmission antenna and the reception antenna, the propagation environment reproduction space is configured according to a specification indicated by a parameter which is set to reproduce a desired characteristic which is a propagation characteristic caused at a measurement position in a real space, the RIS and the transmission antenna are disposed according to the specification indicated by the parameter, and the propagation environment reproduction system is configured to execute: a function of controlling the first RIS such that the first RIS has transmittance indicated by the parameter; and a function of controlling a transmission signal from the transmission antenna such that the transmission antenna transmits an electromagnetic wave with a characteristic indicated by the parameter.

### Advantageous Effects of Invention

According to the first to third aspects, it is possible to control the power of the electromagnetic wave directly reaching the reception antenna from the transmission antenna in the propagation environment reproduction space by using the first RIS that controls transmission (passing through) of the electromagnetic wave. Therefore, according to these aspects, it is possible to improve the accuracy of reproduction of any propagation environment.

### BRIEF DESCRIPTION OF DRAWINGS

FIG. 1 is a diagram illustrating an overall configuration of a propagation environment reproduction device according to a first embodiment of the present disclosure;

FIG. 2 is a flowchart for explaining a procedure of deriving a parameter for reproducing a desired propagation environment in the propagation environment reproduction device illustrated in FIG. 1;

FIG. 3A is a diagram for explaining one of typical characteristics that can be provided to a RIS;

FIG. 3B is a diagram for explaining other typical characteristics that can be provided to the RIS;

FIG. 4 is a diagram for explaining a hardware configuration of a control server included in the device according to the first embodiment of the present disclosure;

FIG. 5 is a flowchart for explaining a flow when evaluating communication performance or the like of a measurement object using the device according to the embodiment of the present disclosure;

FIG. 6 is a diagram illustrating an overall configuration of a propagation environment reproduction device according to a second embodiment of the present disclosure; and

FIG. 7 is a diagram illustrating an overall configuration of a propagation environment reproduction device according to a third embodiment of the present disclosure.

### description of embodiments

### First Embodiment

### Configuration of First Embodiment

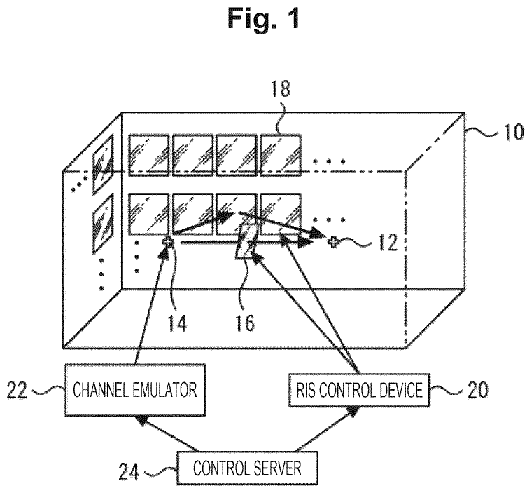

FIG. 1 is a diagram illustrating an overall configuration of a propagation environment reproduction device according to a first embodiment of the present disclosure. The propagation environment reproduction device according to the present embodiment includes an anechoic chamber 10. The anechoic chamber 10 is a chamber capable of blocking an influence of an electromagnetic wave from the outside, and may be referred to as a shielded room or an echo chamber. In the present embodiment, the anechoic chamber 10 is used for the purpose of reproducing a desired propagation environment for a wireless signal, more specifically, an actual propagation environment occurring in a real space such as a city street, in the anechoic chamber 10.

A reception antenna 12 is disposed in the anechoic chamber 10. The reception antenna 12 is an antenna included in a measurement object to be evaluated, and includes, for example, a plurality of antennas for realizing a MIMO function. The reception antenna 12 is installed at a position for simulating a propagation environment caused in a place where a measurement object is disposed in a real space. The reception antenna 12 can also be disposed in the air in the anechoic chamber 10 by being supported by a jig installed on a floor surface of the anechoic chamber 10 or by being suspended from a ceiling.

One or more transmission antennas 14 are disposed in the anechoic chamber 10. The transmission antenna 14 can be held at a certain position in the same manner as in the case of the reception antenna 12. FIG. 1 illustrates an example in which only one transmission antenna 14 is disposed inside the anechoic chamber 10.

One or more first RISs 16 are disposed in an indoor space of the anechoic chamber 10. The position of the RIS 16 can also be arbitrarily set by the same method as in the case of the reception antenna 12. The RIS 16 has a characteristic of causing an electromagnetic wave transmitted (passed through). More specifically, the RIS 16 has a characteristic of making the power of the electromagnetic wave to be passed through variable according to a control signal provided from the outside. By disposing the RIS 16 between the transmission antenna 14 and the reception antenna 12, the power of the direct wave from the transmission antenna 14 toward the reception antenna 12 can be controlled by the RIS 16.

One or more second RISs 18 are disposed inside the anechoic chamber 10. The RIS 18 can be installed on a wall surface, a ceiling, or a floor surface of the anechoic chamber 10. Further, similarly to the RIS 16, the RIS 18 may be disposed in the air in the anechoic chamber 10. A characteristic of changing a reflection direction of the electromagnetic wave, more specifically, a reflection pattern of the electromagnetic wave according to a control signal provided from the outside is provided to the RIS 18. Note that, in the present embodiment, although a variable reflection direction characteristic is provided to the second RIS 18, the characteristic provided to the second RIS 18 is not limited thereto. For example, a variable reflection power characteristic may be provided to the second RIS 18. Furthermore, in the second RIS 18, a RIS having a variable reflection direction characteristic and a RIS having a variable reflection power characteristic may be mixed.

Further, in the anechoic chamber 10, a radio wave absorber (not illustrated) having a function of absorbing an irradiated electromagnetic wave may be disposed at a certain place. According to the radio wave absorber, radio waves unnecessary for simulating a propagation environment in a real space can be eliminated inside the anechoic chamber 10.

A RIS control device 20 is connected to the RIS 16 and the RIS 18. The RIS control device 20 provides a control signal for designating transmission power to the RIS 16, and provides a control signal for designating a reflection pattern to the RIS 18. Thereby, a propagation environment corresponding to the states of the RIS 16 and the RIS 18 is caused inside the anechoic chamber 10.

A channel emulator 22 is connected to the transmission antennas 14. The channel emulator has a function of controlling characteristics of the electromagnetic waves transmitted from the transmission antennas 14. Specifically, the channel emulator 22 can control a radiation direction, power, a radiation timing, and the like of the electromagnetic waves transmitted from the transmission antennas 14.

A control server 24 is connected to the RIS control device 20 and the channel emulator 22. The control server 24 controls the RIS control device 20 and the channel emulator 22 such that a desired propagation environment is reproduced at a position of the reception antenna 12. In a case where specifications of the propagation environment reproduction device are appropriately set and then the RIS control device 20 and the channel emulator 22 are appropriately controlled, a desired propagation environment can be reproduced inside the anechoic chamber 10, particularly, at a position of the reception antenna 12.

The configuration illustrated in FIG. 1 is an example of one form of the propagation environment reproduction device. A shape and a size of the anechoic chamber 10 can be changed. The shape can be, for example, a sphere, an n-hedron (n is an integer), an n-prism, an n-pyramid, or the like.

### Method for Deriving Reproduction Parameter

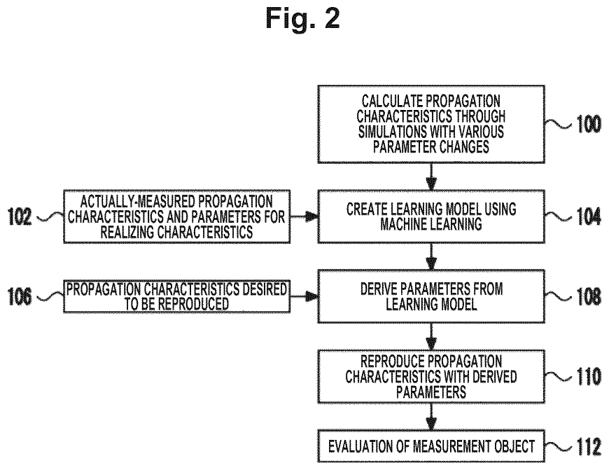

FIG. 2 is a flowchart for explaining a procedure of deriving a parameter for reproducing a desired propagation environment in the propagation environment reproduction device illustrated in FIG. 1.

Here, first, various parameters related to the characteristics of the propagation environment reproduction device are variously changed, and the propagation characteristics occurring in the anechoic chamber 10 under a combination of the respective parameters are calculated by a simulation (step 100). A type of the simulation may be, for example, ray tracing (a ray launching method), ray tracing (an imaging method), electromagnetic field analysis (FDTD method), or the like.

As parameters to be set, for example, the following parameters are used.
A shape, a size, and a material of the anechoic chamber 10
A shape, a size, the number, disposition, and a controllable transmittance of the RIS 16
A shape, a size, the number, disposition, a controllable angle, and a controllable reflectance of the RIS 18
A location and the number of the transmission antenna 14, and characteristics of transmission signals
A location and the number of the reception antenna 12, and characteristics of reception signals
A direction of transmission beams
A position, a size, the number, and a shape of the radio wave absorber

The propagation characteristic is a characteristic of the electromagnetic wave at a reception point, and specifically, the following physical quantity corresponds to the propagation characteristic.
Received power
Cross polarization ratio (XPR, vertical-horizontal power ratio)
Delay time
Arrival direction (horizontal/vertical)
Delay spread
Angle spread
Number of clusters included in a radio wave cluster

After the processing in step 100 is completed, next, a propagation characteristic (hereinafter, “actual characteristic”) actually occurred in a real space is specified. In addition, a parameter (hereinafter, “reproduction parameter”) that causes the actual characteristic in the anechoic chamber 10 is specified based on a result of the above simulation. By repeating this processing, a plurality of sets of actual characteristics and parameters are prepared (step 102).

The “actual characteristic” is a propagation characteristic that is actually measured by the reception antenna 12 in a state where a device including the reception antenna 12 is actually disposed in a real space such as a city street. The “reproduction parameter” is a parameter that causes the “actual characteristic” in the anechoic chamber 10 and is obtained by a simulation. Therefore, in a case where the propagation environment reproduction device is prepared according to the reproduction parameters, the same characteristics as the “actual characteristics” occur inside the propagation environment reproduction device.

The set of “actual characteristics” and “reproduction parameters” is used as training data for machine learning. That is, in the present embodiment, the plurality of data sets prepared in step 102 are provided to a propagation environment model as training data for machine learning. Then, when an actual characteristic is given by repeating learning using a large number of training data, a learning model for deriving a parameter that causes the characteristic in the anechoic chamber 10 is created (step 104).

In a stage where the learning model has been created, a propagation characteristic (hereinafter, “desired characteristic”) to be reproduced in the anechoic chamber 10 is provided to the learning model (step 106).

Thereby, a parameter for causing the desired characteristic in the anechoic chamber 10 is derived from the learning model (step 108).

Thereafter, a propagation environment reproduction device is prepared according to the parameters derived in step 108, and electromagnetic waves from the transmission antenna 14 are transmitted into the propagation environment reproduction device. Thereby, the desired characteristic is reproduced at the position of the reception antenna 12 in the anechoic chamber 10 (step 110).

After the desired characteristics has been reproduced, communication performance, a communication quality, and the like of the reception antenna 12 disposed in the anechoic chamber 10 are measured, and the measurement result is evaluated (step 112).

As described above, according to the propagation environment reproduction device of the present embodiment, performance and the like of the reception antenna 12 can be evaluated in a state where the desired characteristics has been reproduced in the anechoic chamber 10. Therefore, according to the device, it is possible to accurately evaluate the capability of the reception antenna 12 in the real space without performing measurement in the real space.

### Characteristics of RIS

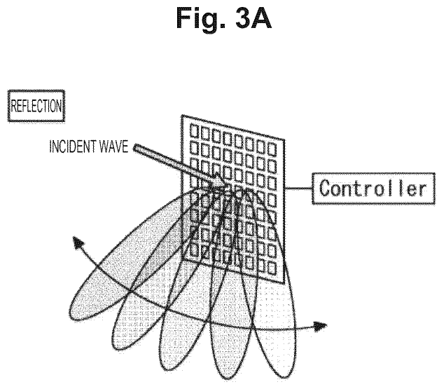

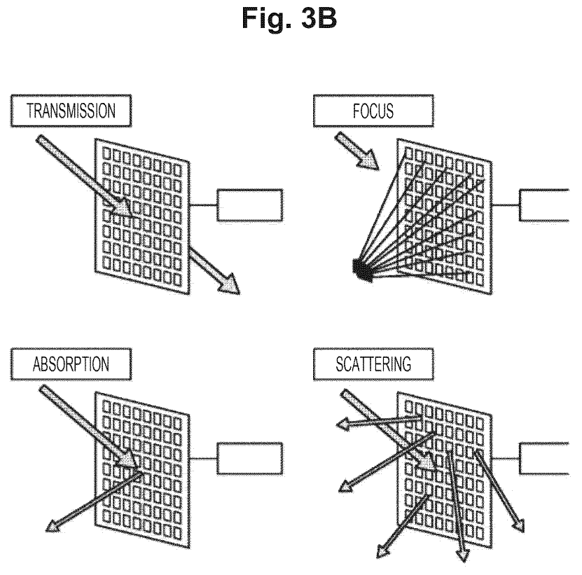

FIG. 3A is a diagram for explaining an example of characteristics that can be provided to the RIS using a metamaterial technology. As illustrated in FIG. 3A, the RIS can be provided with a characteristic of making a direction in which an incident wave is reflected variable according to a control signal provided from the controller.

FIG. 3B illustrates other typical characteristics that can be provided to the RIS. As illustrated in FIG. 3B, the RIS can be provided with a characteristic of transmitting the incident wave, a characteristic of focusing the reflected wave at a specific location, a characteristic of absorbing a part of the incident wave to reduce the intensity and reflecting the incident wave, a characteristic of scattering the incident wave, and the like. In addition to the characteristics illustrated in FIG. 3A, it is also possible to selectively provide the characteristics illustrated in FIG. 3B to the RIS according to the adopted structure.

In the present embodiment, the second RIS 18 is provided with the characteristics shown in FIG. 3A, that is, the characteristics that allow the direction of the reflected wave to be variable. More specifically, the second RIS 18 according to the present embodiment is provided with a characteristic of making the reflection pattern variable according to the control signal.

In addition, the first RIS 16 according to the present embodiment is provided with transmission characteristics illustrated in FIG. 3B. The RIS 16 having the characteristics can change the transmittance of the electromagnetic wave, that is, the power of the electromagnetic wave to be passed through, according to the provided control signal. Therefore, in the present embodiment, the direct wave traveling straight from the transmission antenna 14 toward the reception antenna 12 can be appropriately attenuated or eliminated inside the anechoic chamber 10.

### Hardware Configuration of Control Server

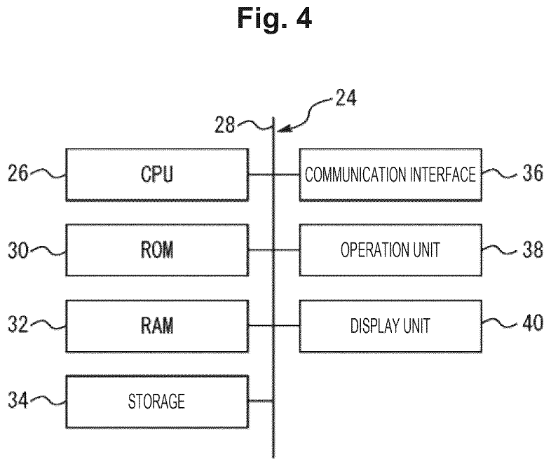

FIG. 4 illustrates a hardware configuration of the control server 24. The control server 24 is configured with a general computer system, and includes a central processing unit (CPU) 26. Memories such as a ROM 30, a RAM 32, and a storage 34 are connected to the CPU 26 via a communication bus 28. The communication bus 28 is further connected to a communication interface 36, and an operation unit 38 and a display unit 40 serving as user interfaces.

In a case where the CPU 26 executes a program stored in the ROM 30, the control server 24 implements the above-described various functions. Specifically, in a case where the CPU 26 executes the processing according to the program, the control server 24 implements the simulation in step 100, the learning in step 104, the parameter derivation in step 108, the control of the RIS 16 and the channel emulator 22 in step 110, and the evaluation of the reception antenna 12 in step 112.

### Evaluation of Measurement Object

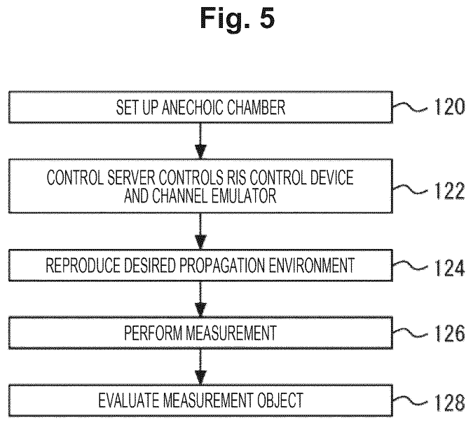

FIG. 5 is a flowchart for explaining in detail the processing of step 110 and step 112 illustrated in FIG. 2. Here, first, the anechoic chamber 10 is set up (step 120). Specifically, the anechoic chamber 10 is set up with the shape, the size, and the material indicated by the parameters derived in step 108. In addition, the RIS 16 that controls transmission according to the parameters, the RIS 18 that controls a reflection direction, the transmission antenna 14, and the reception antenna 12 are installed in the anechoic chamber 10. In a case where the parameter requires installation of the radio wave absorber, the radio wave absorber is also installed.

Next, the control server 24 controls the RIS control device 20 and the channel emulator 22 as indicated by the parameters (step 122).

Thereby, a desired propagation environment simulating the characteristics of the real space is reproduced inside the anechoic chamber 10, particularly, at the position of the reception antenna 12 (step 124). In this step, it may be verified that a desired propagation environment is reproduced using a reception antenna of which the performance is known.

After the desired propagation space is reproduced in the anechoic chamber 10, the control server 24 measures a communication quality and the like of the reception antenna 12 (step 126).

Next, the control server 24 is caused to execute evaluation based on the measurement result (step 128).

As described above, in the present embodiment, the RIS 16 that makes the transmittance of the electromagnetic wave variable is disposed in the anechoic chamber 10. According to the RIS 16, it is possible to appropriately control the behavior of the direct wave from the transmission antenna 14 toward the reception antenna 12 in the anechoic chamber 10. Therefore, according to the propagation environment reproduction device of the present embodiment, it is possible to improve the accuracy of reproduction of any propagation environment.

### Modification Example of the First Embodiment

Note that, in the present embodiment, the control server 24 is caused to perform the simulation in step 100, the learning in step 104, and the parameter derivation in step 108. On the other hand, the present disclosure is not limited thereto. These pieces of processing may be executed by another computer prepared separately from the control server 24.

Further, in the first embodiment, the control server 24 is caused to perform the measurement of the communication quality and the like of the reception antenna 12 and the evaluation based on the measurement result. On the other hand, the present disclosure is not limited thereto. These pieces of processing may be executed by another evaluation device prepared separately from the control server 24.

Further, in the first embodiment described above, the propagation environment in a real space is reproduced in the anechoic chamber 10. On the other hand, the present disclosure is not limited thereto. The space for reproducing the propagation environment may be an outdoor space, or may be a normal indoor space that does not have a shielding function. The same applies to a second embodiment and a third embodiment to be described below.

### Second Embodiment

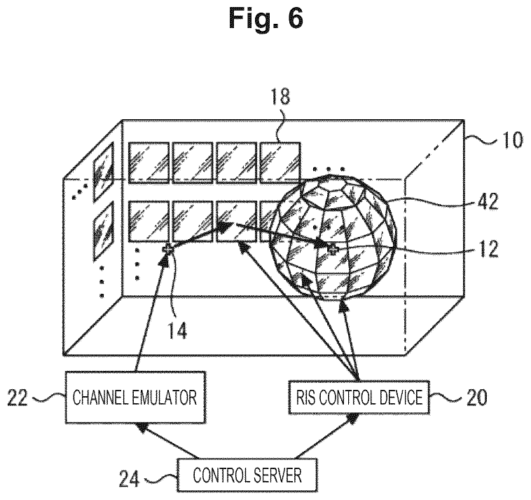

Next, a second embodiment of the present disclosure will be described with reference to FIG. 6.

FIG. 6 is a diagram illustrating an overall configuration of a propagation environment reproduction device according to a second embodiment of the present disclosure. Note that, in FIG. 6, elements that are the same as or correspond to the elements illustrated in FIG. 1 are denoted by the same reference numerals, and redundant description will be omitted.

The propagation environment reproduction device according to the present embodiment includes a sphere RIS 42 instead of the first RIS 16. The sphere RIS 42 is configured by a plurality of RISs arranged in a sphere shape, each RIS having the characteristic of making the transmittance of the electromagnetic wave variable as well as the RIS 16 in the first embodiment. In the present embodiment, the reception antenna 12 is disposed inside the sphere RIS 42, more specifically, at the center point of the sphere RIS 42.

In the present embodiment, the RIS 18 disposed on the wall surface or the like of the anechoic chamber 10 has a characteristic of making the direction of the reflected wave variable as in the case of the first embodiment. In addition, as in the first embodiment, the RIS 18 may be replaced with a device that makes the power of the reflected wave variable. Further, the RISs 18 may include both a RIS that makes the reflection direction variable and a RIS that makes the reflection power variable.

According to the configuration of the present embodiment, the electromagnetic wave toward the reception antenna 12 from any direction needs to pass through the sphere RIS 42 before reaching the reception antenna 12. Therefore, the sphere RIS 42 can control the intensity of light reaching the reception antenna 12 in all directions. That is, according to the sphere RIS 42, the power of the direct wave from the transmission antenna 14 toward the reception antenna 12 can be appropriately controlled, and the power of the reflected light from the RIS 18 can also be appropriately controlled.

Therefore, according to the propagation environment reproduction device of the present embodiment, it is possible to more accurately reproduce any propagation environment as compared with the case of the first embodiment.

### Third Embodiment

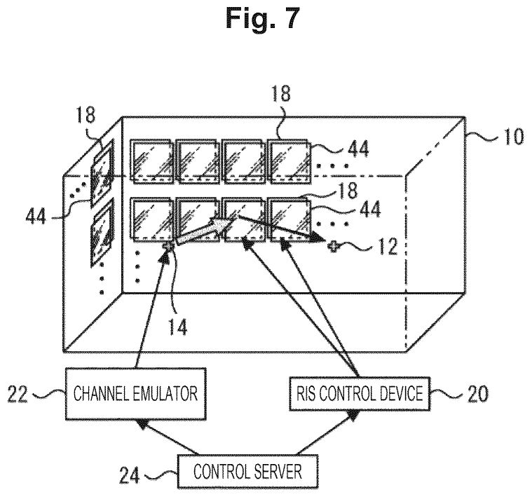

Next, a third embodiment of the present disclosure will be described with reference to FIG. 7.

FIG. 7 is a diagram illustrating main parts of a propagation environment reproduction device according to a third embodiment of the present disclosure. Note that, in FIG. 7, elements that are the same as or correspond to the elements illustrated in FIG. 1 or FIG. 6 are denoted by the same reference numerals, and redundant description will be omitted.

The propagation environment reproduction device of the present embodiment includes one or more surface layers RIS 44 inside the anechoic chamber 10. The surface layer RIS 44 has a characteristic of making the power of the passing through electromagnetic wave variable as well as the first RIS 16 in the first embodiment. Further, each of the surface layers RIS 44 is disposed so as to overlap a surface of each of the second RISs 18 disposed in the anechoic chamber 10. The second RIS 18 has a characteristic of making the reflection direction variable as in the case of the first embodiment or the second embodiment.

In a case where the surface layer RIS 44 is disposed so as to overlap the second RIS 18, the power of the reflected wave from the second RIS 18 can be controlled by controlling a state of the surface layer RIS 44. That is, according to the overlap structure illustrated in FIG. 7, both the direction and the power of the reflected wave can be appropriately controlled by using the functions of the second RIS 18 and the surface layer RIS 44 in combination.

Although not illustrated, the propagation environment reproduction device of the present embodiment includes both or one of the first RIS 16 in the first embodiment and the sphere RIS 42 in the second embodiment. Therefore, the device of the present embodiment also has a function of controlling the direct wave from the transmission antenna 14 toward the reception antenna 12. In addition to this function, in the present embodiment, a function of controlling both the reflection direction and the reflection intensity of the electromagnetic wave is provided to a wall surface or the like of the anechoic chamber 10.

Therefore, according to the propagation environment reproduction device of the present embodiment, it is possible to more accurately reproduce any propagation environment as compared with the case of the first embodiment or the second embodiment.

### Modification Example of the Third Embodiment

Meanwhile, in the above-described third embodiment, the technique of superimposing the surface layer RIS 44 capable of varying the transmission power on the RIS 18 capable of varying a reflection direction arranged on a wall surface or the like is used in combination with the technique of the first embodiment or the second embodiment. However, it is not essential to combine both techniques. The technique of generating a reflector capable of controlling both the reflection direction and the reflected power by overlapping the surface layer RIS 44 on the second RIS 18 can also be used alone separately from the technique of the first embodiment or the second embodiment for controlling the power of the direct wave.

### REFERENCE SIGNS LIST

10 Anechoic chamber
12 Reception antenna
14 Transmission antenna
16 First RIS
18 Second RIS
20 RIS control device
22 Channel emulator
24 Control server
26 CPU
30 ROM
42 Sphere RIS
44 Surface layer RIS

1. A propagation environment reproduction device comprising:
a reconfigurable intelligent surface (RIS) that is installed in a propagation environment reproduction space for reproducing a propagation environment of an electromagnetic wave;
a RIS controller that provides a control signal to the RIS;
a transmission antenna that is installed in the propagation environment reproduction space;
a channel emulator that controls a characteristic of an electromagnetic wave transmitted from the transmission antenna;
a reception antenna that is installed in the propagation environment reproduction space as an evaluation target; and
a control server that controls the RIS controller and the channel emulator,
wherein the RIS includes a first RIS that has a characteristic of changing transmittance of the electromagnetic wave according to the control signal and is disposed between the transmission antenna and the reception antenna.

2. The propagation environment reproduction device according to claim 1, wherein the RIS includes a sphere RIS configured by disposing the first RIS in a spherical shape so as to surround the reception antenna.

3. The propagation environment reproduction device according to claim 1, wherein the RIS includes a second RIS that has a characteristic of changing a reflection direction of the electromagnetic wave according to the control signal and is disposed at least one of on a wall surface, on a ceiling, or on a floor surface, or in the air of the propagation environment reproduction space.

4. The propagation environment reproduction device according to claim 1:
wherein the RIS includes:
a second RIS that has a characteristic of changing a reflection direction of the electromagnetic wave according to the control signal and is disposed at least one of on a wall surface, on a ceiling, or on a floor surface, or in the air of the propagation environment reproduction space, and
a third RIS that has a characteristic of changing transmittance of the electromagnetic wave according to the control signal, the first RIS being a surface layer RIS disposed so as to overlap a surface of the second RIS.

5. The propagation environment reproduction device according to claim 1, wherein
the propagation environment reproduction space is configured according to a specification indicated by a parameter which is set to reproduce a desired characteristic which is a propagation characteristic caused at a measurement position in a real space,
the RIS and the transmission antenna are disposed according to the specification indicated by the parameter, and
the control server is configured to execute:
controlling the RIS controller such that the first RIS has transmittance indicated by the parameter; and
controlling the channel emulator such that the transmission antenna transmits the electromagnetic wave with a characteristic indicated by the parameter.

6. A propagation environment reproduction method for reproducing a desired propagation environment at a position of a reception antenna that is installed in a propagation environment reproduction space for reproducing a propagation environment of an electromagnetic wave by using a RIS that is installed in the propagation environment reproduction space and a transmission antenna that is installed in the propagation environment reproduction space, the RIS including a first RIS that has a characteristic of changing transmittance of the electromagnetic wave according to the control signal and is disposed between the transmission antenna and the reception antenna, the propagation environment reproduction method including:
calculating, while changing parameters related to the propagation environment reproduction space, the RIS, and the transmission antenna, a propagation characteristic caused in the propagation environment reproduction space under each of said parameters by a simulation;
creating a learning model that derives, when a propagation characteristic to be reproduced is provided, a parameter causing said propagation characteristic in the propagation environment reproduction space, the learning model being obtained by providing to a propagation environment model as training data a combination of an actual characteristic that is a propagation characteristic actually measured at a measurement position in a real space and a reproduction parameter that is a parameter calculated to cause a propagation characteristic which is same as the actual characteristic in the propagation environment reproduction space;
causing the learning model to derive a parameter for causing a desired propagation characteristic by providing the desired propagation characteristic to the learning model;
configuring the propagation environment reproduction space according to a specification indicated by the parameter derived by the learning model;
disposing the RIS and the transmission antenna in the propagation environment reproduction space according to the specification indicated by the parameter derived by the learning model;
controlling the first RIS such that the first RIS has transmittance indicated by the parameter derived by the learning model; and
controlling a transmission signal from the transmission antenna such that the transmission antenna transmits an electromagnetic wave with a characteristic indicated by the parameter derived by the learning model.

7. The propagation environment reproduction method according to claim 6, wherein the RIS includes a sphere RIS configured by disposing the first RIS in a spherical shape so as to surround the reception antenna.

8. A propagation environment reproduction system comprising:
a RIS that is installed in a propagation environment reproduction space for reproducing a propagation environment of an electromagnetic wave;
a transmission antenna that is installed in the propagation environment reproduction space; and
a reception antenna that is installed in the propagation environment reproduction space as an evaluation target,
wherein the RIS includes a first RIS that has a characteristic of changing transmittance of the electromagnetic wave according to the control signal and is disposed between the transmission antenna and the reception antenna,
the propagation environment reproduction space is configured according to a specification indicated by a parameter which is set to reproduce a desired characteristic which is a propagation characteristic caused at a measurement position in a real space,
the RIS and the transmission antenna are disposed according to the specification indicated by the parameter, and
the propagation environment reproduction system is configured to execute:
controlling the first RIS such that the first RIS has transmittance indicated by the parameter; and
controlling a transmission signal from the transmission antenna such that the transmission antenna transmits an electromagnetic wave with a characteristic indicated by the parameter.

9. The propagation environment reproduction device according to claim 2, wherein the RIS includes a second RIS that has a characteristic of changing a reflection direction of the electromagnetic wave according to the control signal and is disposed at least one of on a wall surface, on a ceiling, or on a floor surface, or in the air of the propagation environment reproduction space.
